(19) United States
(12) Patent Application Publication
(10) Pub. No.: US 2003/0069746 A1
(43) Pub. Date: Apr. 10, 2003

(54) Business card managing system, method and program thereof, business card managing server and program thereof, portable terminal for business-card exchange and program thereof

(75) Inventor: Hiroyasu Kuramatsu, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/265,772

(22) Filed: Oct. 8, 2002

(30) Foreign Application Priority Data
Oct. 9, 2001 (JP) 2001-311915

(51) Int. Cl. G06F 17/60

(52) U.S. Cl. 705/1

(57) ABSTRACT

A business card managing system that is available even to users whose portable terminals have little memory capacity, wherein when business cards are electrically exchanged between two persons, and thereafter, the data of either person is updated, the update is easily reflected on the business card. A business card managing server comprises a first database for managing all registered personal information and a second database composed of areas assigned to respective users. A portable terminal sends, via a network, a business card ID received through an external interface means to the business card managing server to register the business card ID in the second database. When receiving the business card ID from the portable terminal, the business card managing server sends personal information about a user, the personal information being managed in the first database and corresponding to the business card ID, back to the portable terminal via the network.

### BACKGROUND OF THE INVENTION

The present invention relates to a business card managing system for exchanging electronic business cards utilizing portable terminals, a method and a program thereof, a business card managing server and a program thereof, and a portable terminal for exchanging the electronic business cards and a program thereof.

### DESCRIPTION OF THE RELATED ART

A business card managing service on a network is popular nowadays. In addition, portable terminals have acquired abilities of data communication and on-line games between the terminals utilizing a communication means such as IrDA (Infrared Data Association). According to such movement, there is commercialized a portable terminal capable of electronically exchanging business cards or personal information.

As prior techniques for exchanging electronic business cards, Japanese Patent Application Laid-Open No. HEI8-8962 discloses a technique to boot up an online business card exchanging system owned by both parties to exchange latest business cards via a communication line and accumulate them in respective business card databases.

Japanese Patent Application Laid-Open No. HEI8-69439 discloses a technique in which an owner of an electronic information apparatus transmits and receives personal data to and from an owner of another electronic information apparatus through an infrared transmitter and receiver, thus enabling exchange of personal data between the owners.

Japanese Patent Application Laid-Open No. HEI10-105610 discloses a business card information managing server to receive business card information stored in a recording medium via a communication line to manage the received information.

Japanese Patent Application Laid-Open No. HEI 11-355442 discloses a technique in which a personal information managing device provided on the Internet manages personal information transmitted from radiotelephone equipment via the Internet.

In addition, Japanese Patent No. 2708017 discloses a technique in which an owner of an electronic information apparatus transmits and receives personal data to and from an owner of another electronic information apparatus using a communication means such as an infrared transmitting and receiving means, thus enabling an exchange of personal data between the owners.

In some of the above-described techniques, a managing server includes a database used for managing personal information for business-card exchange. However in the applications and JP2708017, there is not disclosed and suggested a managing server provided with a database for managing data for business-card exchange of all users participating in the system and a database for managing data with respect to each user.

In addition, even if employing the conventional technique, it is impossible to obtain such advantage as is obtained by the present invention, which enables users to exchange electronic business cards without carrying around paper cards and produces the same effect as in the case of putting the exchanged business cards in a business card file on the moment.

### SUMMARY OF THE INVENTION

It is therefore an object of the present invention to provide a business card managing system that is available even when a memory capacity of a user terminal is small, wherein when business cards are electrically exchanged between two person, and thereafter, the data of either person is updated, the update is easily reflected on the exchanged business card, a method and a program thereof, a business card managing server and a program thereof, and a portable terminal for business-card exchange and a program thereof.

According to a first aspect of the present invention, for achieving the objects mentioned above, there is provided a business card managing system comprising:

a business card managing server including a first database for managing all personal information registered by a plurality of users via a network and a second database composed of areas assigned for the respective users; and

a plurality of portable terminals each including an external interface to exchange business card IDs used for accessing the personal information managed by the business card managing server, wherein:

the portable terminal sends via the network the business card ID received through the external interface to the business card managing server to register the business card ID in the second database;

when receiving the business card ID from the portable terminal, in the case where the business card ID has been registered in an area for a user of the portable terminal in the second database, the business card managing server sends personal information that is managed in the first database and corresponds to the business card ID back to the portable terminal via the network.

According to a second aspect of the present invention, in the first aspect, the personal information is registered and updated through the portable terminal or a personal computer via the network; and

when receiving the business card ID from the portable terminal, in the case where the business card ID has been registered in the area for the user of the portable terminal in the second database, the business card managing server sends the latest personal information that corresponds to the business card ID back to the portable terminal.

According to a third aspect of the present invention, in the first or second aspect, when the portable terminal exchanges business card IDs with another portable terminal through the external interface, the portable terminals exchange data to identify users of the business card IDs along with the respective business card IDs to have each user confirm authenticity of the business card ID of the other party.

According to a fourth aspect of the present invention, in one of the first to third aspects, the portable terminal includes a means to discard the business card ID received from the another portable terminal through the external interface according to a direction from the user of the portable terminal.

According to a fifth aspect of the present invention, there is provided a business card managing method comprising:

a business card ID sending step for sending, from a portable terminal via a network, a business card ID acquired from another portable terminal to a business card managing server that includes a first database for managing all personal information registered from a plurality of users and a second database composed of areas assigned for the respective users;

a registering step for registering the business card ID sent in the business card ID sending step in an area for a user of the portable terminal in the second database; and

a personal information sending step for, when the business card managing server receives the business card ID from the portable terminal, in the case where the business card ID has been registered in the area for the user of the portable terminal in the second database, sending personal information that is managed in the first database and corresponds to the business card ID back to the portable terminal via the network.

According to a sixth aspect of the present invention, there is provided a business card managing method comprising:

a first business card ID sending step for sending a business card ID of a user of a portable terminal from an external interface of the portable terminal to a portable terminal of an exchange party, the business card ID being registered in a business card managing server that includes a first database for managing all personal information registered by a plurality of users and a second database composed of areas assigned for the respective users;

a business card ID receiving step for receiving, from the external interface, a business card ID of the exchange party sent from the portable terminal of the exchange party;

a second business card ID sending step for sending the business card ID received in the business card ID receiving step to the business card managing server via a network;

a registering step for registering the business card ID sent in the second business card ID sending step in an area for the user of the portable terminal in the second database; and

a personal information sending step for, when the business card managing server receives the business card ID from the portable terminal, in the case where the business card ID has been registered in the area for the user of the portable terminal in the second database, sending personal information that is managed in the first database and corresponds to the business card ID back to the portable terminal via the network.

According to a seventh aspect of the present invention, in the fifth or sixth aspect, the business card managing method further includes a registering and updating step for registering and updating the personal information through the portable terminal or a personal computer via the network, wherein in the personal information sending step, when the business card managing server receives the business card ID from the portable terminal, in the case where the business card ID has been registered in the area for the user of the portable terminal in the second database, the latest personal information that corresponds to the business card ID is sent back to the portable terminal.

According to an eighth aspect of the present invention, in the sixth aspect, in the first business card ID sending step, at the time of sending the business card ID to the portable terminal of the exchange party, data sufficient to identify the user of the business card ID is sent along with the business card ID. In addition, the business card managing method further includes a confirming step for having the user of the portable terminal confirm authenticity of the business card ID after the user receives the data for identification along with the business card ID in the business card ID receiving step.

According to a ninth aspect of the present invention, in the sixth or eighth aspect, the business card managing method further includes a business card ID discarding step for discarding the business card ID according to a direction from the user of the portable terminal after receiving the business card ID in the business card ID receiving step.

According to a tenth aspect of the present invention, there is provided a computer readable program to have a computer execute:

a business card ID sending process for sending, from a portable terminal via a network, a business card ID acquired from another portable terminal to a business card managing server that includes a first database for managing all personal information registered by a plurality of users and a second database composed of areas assigned for the respective users;

a registering process for registering the business card ID sent by the business card ID sending process in an area for a user of the portable terminal in the second database; and

a personal information sending process for, when the business card managing server receives the business card ID from the portable terminal, in the case where the business card ID has been registered in the area for the user of the portable terminal in the second database, sending personal information that is managed in the first database and corresponds to the business card ID back to the portable terminal via the network.

According to an eleventh aspect of the present invention, there is provided a computer readable program to have a computer execute:

a first business card ID sending process for sending a business card ID of a user of a portable terminal from an external interface of the portable terminal to a portable terminal of an exchange party, the business card ID being registered in a business card managing server that includes a first database for managing all personal information registered by a plurality of users and a second database composed of areas assigned for the respective users;

a business card ID receiving process for receiving, from the external interface, a business card ID of the exchange party sent from the portable terminal of the exchange party;

a second business card ID sending process for sending the business card ID received by the business card ID receiving process to the business card managing server via a network;

a registering process for registering the business card ID sent by the second business card ID sending process in an area for the user of the portable terminal in the second database; and

a personal information sending process for, when the business card managing server receives the business card ID from the portable terminal, in the case where the business card ID has been registered in the area for the user of the portable terminal in the second database, sending personal information that is managed in the first database and corresponds to the business card ID back to the portable terminal via the network.

According to a twelfth aspect of the present invention, in the tenth or eleventh aspect, the computer readable program has a computer further execute a registering and updating process for registering and updating the personal information through the portable terminal or a personal computer via the network, wherein by the personal information sending process, when the business card managing server receives the business card ID from the portable terminal, in the case where the business card ID has been registered in the area for the user of the portable terminal in the second database, the latest personal information that corresponds to the business card ID is sent back to the portable terminal.

According to a thirteenth aspect of the present invention, there is provided a business card managing server

comprising:

a first database for managing all personal information registered by a plurality of users via a network; and

a second database that is composed of areas assigned for the respective users in each of which at least one business card ID used as a key to accessing the personal information is registered from a portable terminal via a network; and

when receiving the business card ID from the portable terminal, in the case where the business card ID has been registered in an area for a user of the portable terminal in the second database, sending personal information that is managed in the first database and corresponds to the business card ID back to the portable terminal via the network.

According to a fourteenth aspect of the present invention, in the thirteenth aspect, the business card managing server registers and updates the personal information sent through the portable terminal or a personal computer via the network; and

when receiving the business card ID from the portable terminal, in the case where the business card ID has been registered in the area for the user of the portable terminal in the second database, sends the latest personal information that corresponds to the business card ID back to the portable terminal.

According to a fifteenth aspect of the present invention, there is provided a computer readable program for controlling a business card managing server that includes a first database for managing all personal information registered by a plurality of users and a second database composed of areas assigned for the respective users, to have a computer execute:

a registering process for registering a business card ID sent from a portable terminal via a network in an area for a user of the portable terminal in the second database; and

a personal information sending process for, when the business card managing server receives the business card ID from the portable terminal, in the case where the business card ID has been registered in the area for the user of the portable terminal in the second database, sending personal information that is managed in the first database and corresponds to the business card ID back to the portable terminal via the network.

According to a sixteenth aspect of the present invention, in the fifteenth aspect, the computer readable program has a computer further execute a registering and updating process for registering and updating the personal information sent from the portable terminal or a personal computer via the network, wherein by the personal information sending process, when the business card managing server receives the business card ID from the portable terminal, in the case where the business card ID has been registered in the area for the user of the portable terminal in the second database, the latest personal information that corresponds to the business card ID is sent back to the portable terminal.

According to a seventeenth aspect of the present invention, there is provided a portable terminal comprising:

an external interface to exchange business card IDs used for accessing personal information managed in a business card managing server with another portable terminal in a range of local communication; and

a network interface means to send a business card ID acquired from the another portable terminal through the external interface to the business card managing server via a network, and receive the latest personal information of a user of the another portable terminal, the latest personal information corresponding to the business card ID, from the business card managing server.

According to an eighteenth aspect of the present invention, in the seventeenth aspect, the portable terminal further includes, when the portable terminal exchanges business card IDs with another portable terminal through the external interface, a means to exchange data to identify users of the business card IDs along with the respective business card IDs to have each user confirm authenticity of the business card ID of the other party.

According to a nineteenth aspect of the present invention, in the seventeenth or eighteenth aspect, the portable terminal further includes a means to discard the business card ID received from the another portable terminal through the external interface according to a direction from the user of the portable terminal.

According to a twentieth aspect of the present invention, there is provided a computer readable program to have a computer execute:

a first business card ID sending process for sending a business card ID of a user of a portable terminal from an external interface of the portable terminal to a portable terminal of an exchange party, the business card ID also being registered in a business card managing server;

a business card ID receiving process for receiving, from the external interface, a business card ID of the exchange party sent from the portable terminal of the exchange party;

a second business card ID sending process for sending the business card ID received by the business card ID receiving process to the business card managing server via a network; and

a personal information receiving process for receiving the latest personal information of the user of the another portable terminal, the latest personal information corresponding to the business card ID sent by the second business card ID sending process, from the business card managing server via the network.

According to a twenty-first aspect of the present invention, in the twentieth aspect, by the first business card ID sending process, at the time of sending the business card ID to the portable terminal of the exchange party, data to identify the user of the business card ID is sent along with the business card ID. In addition, the program has the computer further execute a confirming process for having the user of the portable terminal confirm authenticity of the business card ID after the user receives the data along with the business card ID by the business card ID receiving step.

According to a twenty-second aspect of the present invention, in the twentieth or twenty-first aspect, the computer readable program has the computer further execute a business card ID discarding process for discarding the business card ID according to a direction from the user of the portable terminal after receiving the business card ID by the business card ID receiving process.

As described above, the server is provided with the database for storing personal information of all users participating in the system and the independent area (the database) for managing, with respect to each user, business-card information and the like obtained by the exchange of the business cards. By this means, it becomes possible to eliminate the need for reserving memory for the exchanged business-card information in the user terminal. In addition, when personal information is updated, the update can be easily reflected on the business card by processing in the server. Thereby, users can obtain the latest information about business cards at any time.

### BRIEF DESCRIPTION OF THE DRAWINGS

The objects and features of the present invention will become more apparent from the consideration of the following detailed description taken in conjunction with the accompanying drawings in which:

FIG. 1 is a block diagram showing a system configuration of a business card managing system according to embodiments of the present invention;

FIG. 2 is a block diagram showing an internal configuration in a portable terminal used in the business card managing system according to the embodiments of the present invention;

FIG. 3 is a flowchart for explaining behavior of a business card managing system (a business card managing method) according to a first embodiment of the present invention;

FIG. 4 is a flowchart for explaining behavior of a business card managing system (a business card managing method) according to a second embodiment of the present invention;

FIG. 5 is a flowchart for explaining behavior of a business card managing system (a business card managing method) according to a third embodiment of the present invention;

FIG. 6 is a diagram showing transition of images displayed on display sections of portable terminals according to the first embodiment;

FIG. 7 is a diagram showing an image displayed on a display section of a portable terminal according to the first embodiment;

FIG. 8 is a diagram showing transition of images displayed on display sections of portable terminals according to the second embodiment;

FIG. 9 is a business card data management table according to the embodiments of the present invention; and

FIG. 10 is a personal data management table according to the embodiments of the present invention.

### DESCRIPTION OF THE PREFERRED EMBODIMENTS

Referring now to the drawings, embodiments of the present invention are explained in detail.

First, an explanation is given of a rough outline of the present invention. In reference to FIG. 3, users A and B as owners of portable terminals open browsers (Steps A31 and B31) to open business card exchange contents, respectively (Steps A32 and B32). Either of the users A or B (hereat the user A) manipulates the portable terminal to start an exchange of business cards (Step A33). The portable terminal A sends its business card ID (A) to the portable terminal B through an external IF (IrDA or the like) (Step A34). The portable terminal B receives the business card ID (A) through an external IF (IrDA or the like) (Step B34) and sends its business card ID (B) to the portable terminal A through the external IF (Step B35). The portable terminal A receives the business card ID (B) through the external IF (Step A35).

Subsequently, both of the portable terminals A and B log into a server to send thereto the business card IDs (B) and (A) obtained by the exchange, respectively (Steps A36 and B36). The server registers the data of the business card IDs (A) and (B) (Steps A37 and B37). In addition to that, the server sends registered data (business-card information) corresponding to the business card IDs (A) and (B) to the portable terminals B and A, respectively (Steps A38 and B38). Both of the portable terminals A and B display the transmitted data on their displays (Steps A39 and B39).

In the following, a detailed explanation is given of embodiments of the present invention referring to the drawings.

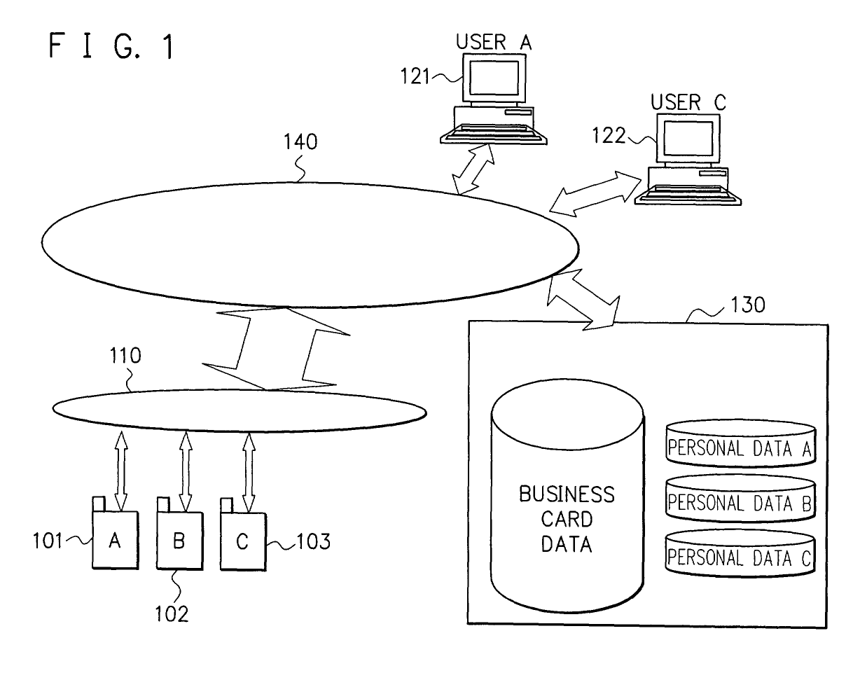

FIG. 1 is a block diagram showing a system configuration of a business card managing system of the present invention. As shown in FIG. 1, the business card managing system of the present invention comprises a plurality of portable terminals (A, B and C) 101 to 103 such as mobile phones, a portable terminal network 110 including management/control/communication networks for the portable terminals 101 to 103, a plurality of information processors (A, C) 121 and 122 such as personal computers and work stations, a service provider (server) 130 including databases for providing business card managing service, and a communication network 140 such as the Internet for connecting those to each other. Incidentally, to utilize the business card managing service, users have to execute in advance user registration, etc. in the business card managing service provider 130.

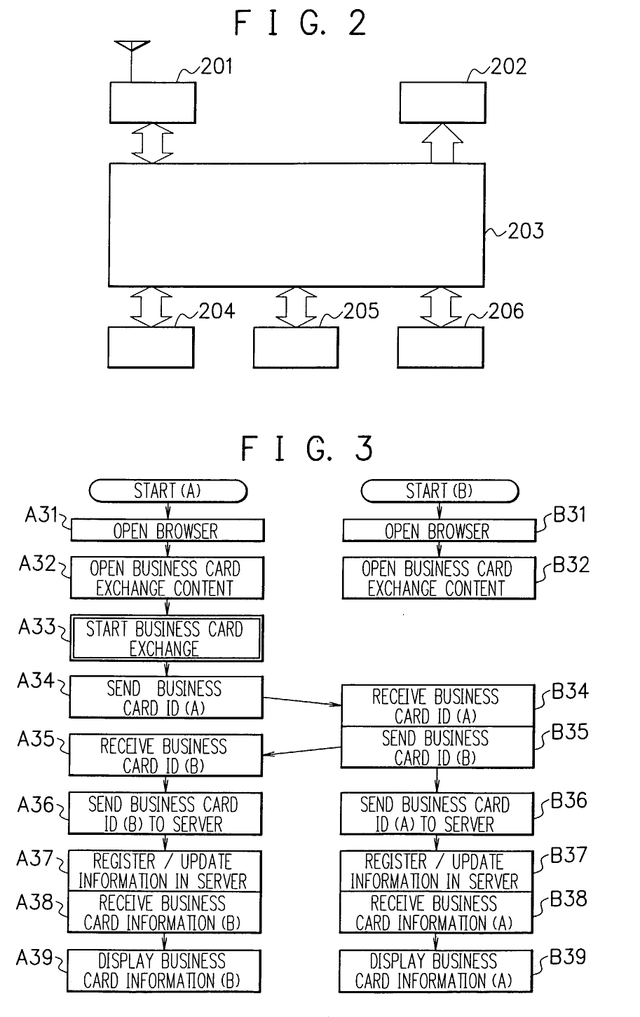

FIG. 2 is a block diagram showing an internal configuration of a portable terminal used in the business card managing system of the present invention. The portable terminal is a wireless terminal device such as a mobile phone, comprising a radio section 201, a display section 202, a control section 203, an operating section 204 including keys, switch buttons and the like, an external IF (InterFace) section 205 based on IrDA (Infrared Data Association) or the like, and a memory section 206 for storing a program(s) and various data. Moreover, the portable terminal can be connected to the network 140 based on, for example, i-mode® or WAP (Wireless Application Protocol) via the portable terminal network 110. Further, the portable terminal is provided with a browser and thereby has a browsing function including a browser cache (function) for caching downloaded information, data and the like to browse contents. The external IF section 205 has a function to communicate data with another portable terminal via its external IF.

[First Embodiment]

In the following, an explanation is given of a first embodiment of the present invention referring to FIGS. 1 to 3, 6, 7, 9 and 10. Incidentally, it is assumed that the network 140 is the Internet in the following explanation.

In the system shown in FIG. 1, the user A owns the portable terminal A101 capable of accessing the Internet 140 via the portable terminal network 110. In addition, the user A also owns a personal computer A121 also capable of accessing the Internet 140. The user A has made a contract with the business card managing service provider 130. On the other hand, the user B owns only a portable terminal B102 capable of accessing the Internet 140, and has made a contract with the provider 130. The condition of the user C is the same as that of the user A.

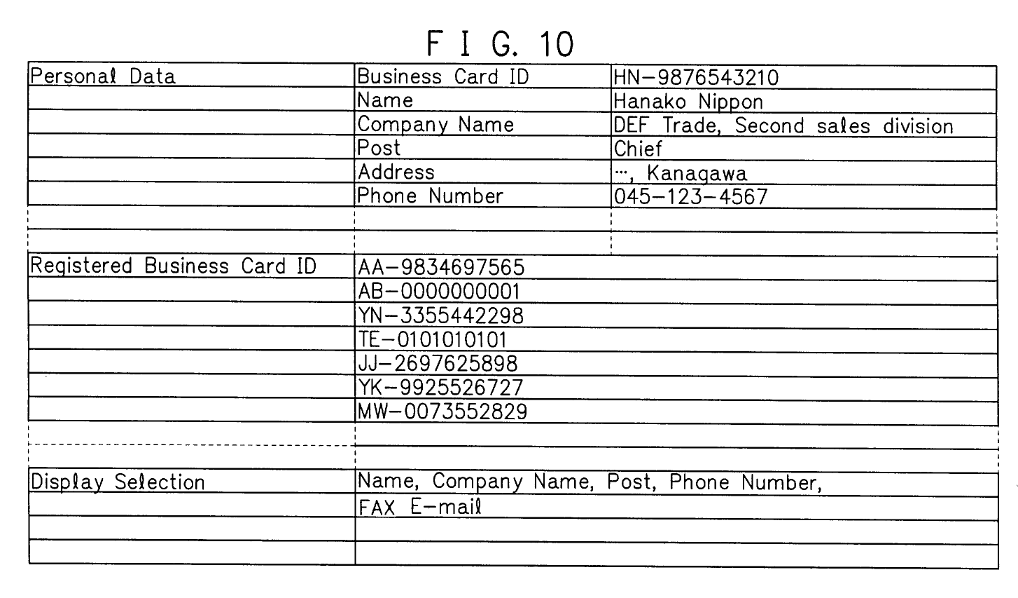

To utilize the business card managing service, the users A, B and C register personal data in the service provider 130 using the portable terminals 101 to 103 or the PC 121 and 122. The content of the personal data may be configured as shown in FIG. 10. For example, the respective users register their names, company names, posts, addresses, facsimile numbers, e-mail addresses and the like.

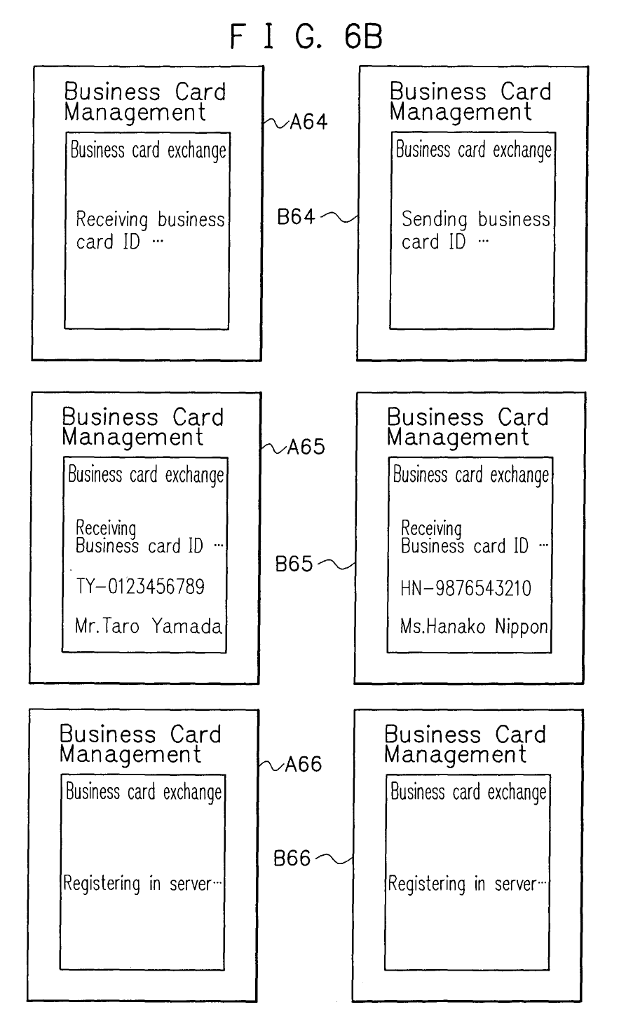

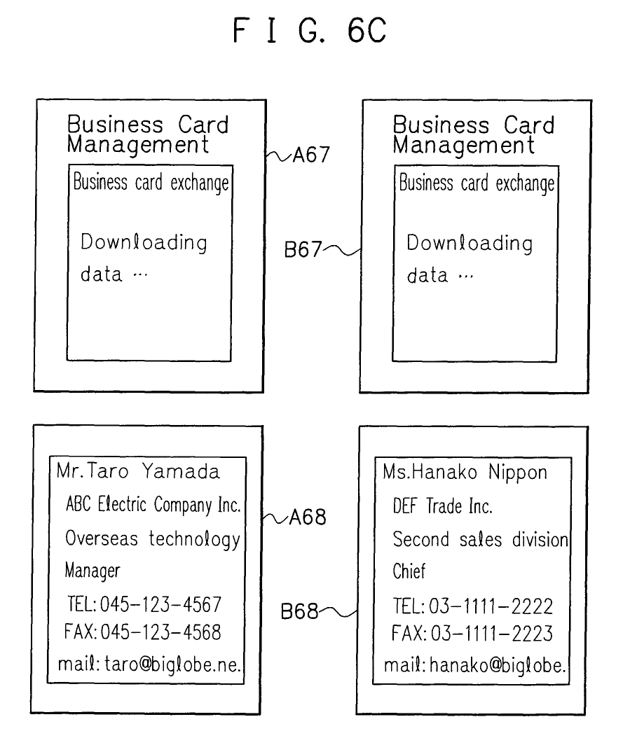

In the following, an explanation is given of a case where the user A who owns the portable terminal A101 and the user B who owns the portable terminal B102 exchange business cards with each other at meeting, etc. referring to FIGS. 2, 3, and 6. FIG. 3 is a flowchart for explaining behavior of the business card managing system (a business card managing method) according to the first embodiment of the present invention. FIG. 6 is a diagram showing transition of images displayed on the display sections of the portable terminals A and B, respectively. Incidentally, the user A operates the portable terminal A101, and the user B operates the portable terminal B102.

In FIG. 3, the users A and B operate the operating sections 204 of the portable terminals A101 and B102 to display the browsers on the respective display sections 202 (Steps A31 and B31). Further, the users A and B operates the operating sections 204 to open business card exchange contents, respectively (Steps A32 and B32). At this point, the control sections 203 of both terminals try to establish connection with the Internet 140 via the portable terminal network 110 from the radio sections 201, respectively.

If succeeding in the establishment of the connection, the contents provided by the business card exchanging service provider server 130 are displayed on the display sections 202, respectively. On the other hand, when failing in the establishment of the connection, the contents stored in the memory sections 206 are displayed thereon (Images A61 and B61 shown in FIG. 6). The users A and B operate the operating sections 204 to select the “Business card exchange” on the screen displays, respectively (Images A61 and B61).

After the users A and B have finished the above processes, either user A or B (hereat, the user A) operates the operating section 204 to select “Start” on the screen display (Step A33) (Images A62 and B62). The control section 203 of the portable terminal A101 sends its business card ID (A) to the portable terminal B102 via the external IF section 205 thereof (Step A34). The portable terminal B102 receives the ID (A) via the external IF section 205 thereof (Step B34) (Images A63 and B63).

Subsequently, the portable terminal B102 sends the business card ID (B) to the portable terminal A101 via the external IF section 205 thereof (Step B35). The portable terminal A101 receives the ID (B) via the external IF section 205 thereof (Step A35) (Images A64 and B64). Along with the business card IDs, minimal necessary data such as users' names may be transmitted, thereby enabling the names to be displayed on the respective display sections 202 at the time of receiving the business card IDs (Images A65 and B65).

Having finished the exchange of the business card IDs, the portable terminals A101 and B102 sends the received business card IDs to the server 130 (Steps A36 and B36). When the portable terminals A101 and/or B102 are/is in the region outside of the service of the portable terminal network 110, that is, in the region outside of communication range, the terminal(s) executes the following operation after entering in the region within communication range.

When the portable terminals are in the region within communication range, the server 130 registers the business card ID (B) sent from the user A in the area for the user A (in the area described as personal data A in FIG. 1) in the database that manages personal data (hereinafter referred to as “personal database”) (Step A37 and Image A66). In the same manner, the server 130 registers the business card ID (A) sent from the user B in the area for the user B (in the area described as personal data B in FIG. 1) in the personal database (Step B37 and Image B66). Subsequently, the server 130 retrieves data corresponding to the business card IDs (A) and (B) from the database that manages business card data (hereinafter referred to as “business card database”) to send the retrieved data to the portable terminals B102 and A101, respectively. The portable terminals A101 and B102 receive the data (Steps A38 and B38) (Images A67 and B67) to display the business card information on the display sections 202, respectively (Steps A39 and B39) (Images A68 and B68).

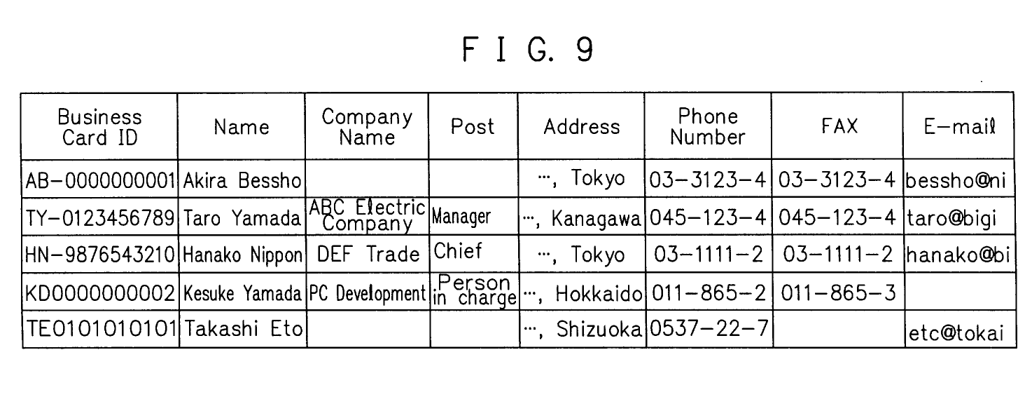

Examples of data configuration in the server 130 depicted in FIG. 1 are given in FIGS. 9 and 10. FIG. 9 shows an example of a data configuration in the business card database, and FIG. 10 shows an example of a data configuration in the personal database.

As shown in FIG. 9, business card database includes columns of a business card ID, personal data, that is, personal information (such as a name, a company name, a post, etc.) and the like, which are registered by each user.

As shown in FIG. 10, the personal database includes items of personal data (personal information), registered business card ID(s), display selection and the like. The personal data can be updated from the PCs 121, 122 and the portable terminals 101 to 103. When the personal data is updated, the corresponding data in the business card database is also updated. In the field of the registered business card IDs, there is stored a list of business card IDs of the other parties with whom a user has exchanged business cards. The data (list) can be changed and modified through the PCs and the portable terminals.

A display section of a portable terminal is small compared to that of a PC, accordingly limiting an amount of information to be displayed. In addition, a memory capacity of the portable terminal is small. Consequently, there is a need to download only necessary information to the portable terminal. To satisfy the need, information to be downloaded to the portable terminal is selected by choosing and registering required items (data) in the section of the display selection in the table shown in FIG. 10.

To display the business card data on the display section 202 of the portable terminal, there are two methods: one is to access the internet 140 to download the data from the business card service provider server 130; and the other is to display the data stored in the memory section 206 of the portable terminal.

The latter method is convenience when the portable terminal is in the region outside of the service and if desired business-card data has been downloaded to the portable terminal. When downloaded, the data is cached in the memory section 206 by the browser cache function of the portable terminal. Thereby, the data can be displayed on the display screen even when in the region outside of communication range.

On the other hand, when using the former method to access the Internet 140 to download the data, the data corresponding to the registered business card ID of the personal data is downloaded from the business card database.

For example, when a user updates his or her personal data after exchanging his or her business card because of the change of his or her position in a company, the corresponding business card data in the business card database is also updated. When an exchange party tries to look at (browse) the business card of the user afterwards, the updated data is to be downloaded to the portable terminal of the exchange party (and data in the memory 206 is also to be updated). Thereby, the exchange party can acquire the latest information at any time.

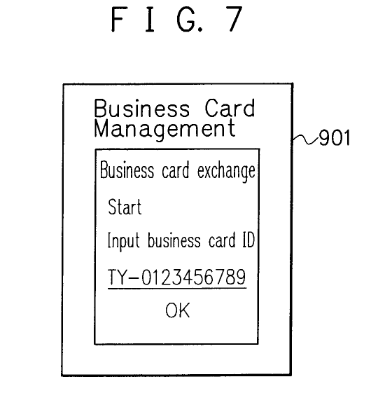

In the above description, there is explained a case where business cards are exchanged between two portable terminals both having the external IF sections 205. In this case, the respective business card IDs are transmitted from the other portable terminals, and the received IDs are sent to the server. Thereby, there is no need to input the IDs. However, when two portable terminals do not have the external IF sections 205 or when the configurations (standards) of the external IF sections 205 are different from each other (for example, when the external IF section 205 of the portable terminal A101 is based on IrDA and that of the portable terminal B102 is based on Bluetooth), it is possible to input the respective business card IDs by the operating sections 204, for example, by hand. FIG. 7 shows an image display in such case. The users manipulates the operating sections 204 to input the business card IDs of the other parties referring to the image display, respectively. Thereafter, the same processes in and after the Steps A36 and B36 shown in the flowchart of FIG. 3 are executed.

[Second Embodiment]

In the following, a detailed explanation is given of a second embodiment of the present invention referring to FIGS. 1, 2, 4 and 8. In the first embodiment, the external IF sections 205 are configured based on IrDA or the like, that is, the sections 205 have directivity to identify the other party. To the contrary, in the second embodiment, the external IF sections 205 are devices based on Bluetooth, etc. that uses weak radio waves, namely, the sections 205 have less or no directivity. This may lead to difficulty in identification of the other party. However, according to the second embodiment, by using such external IF sections, it becomes possible to infallibly exchange data (business card IDs) with each other by sending information such as name to confirm the other party before exchange business card IDs.

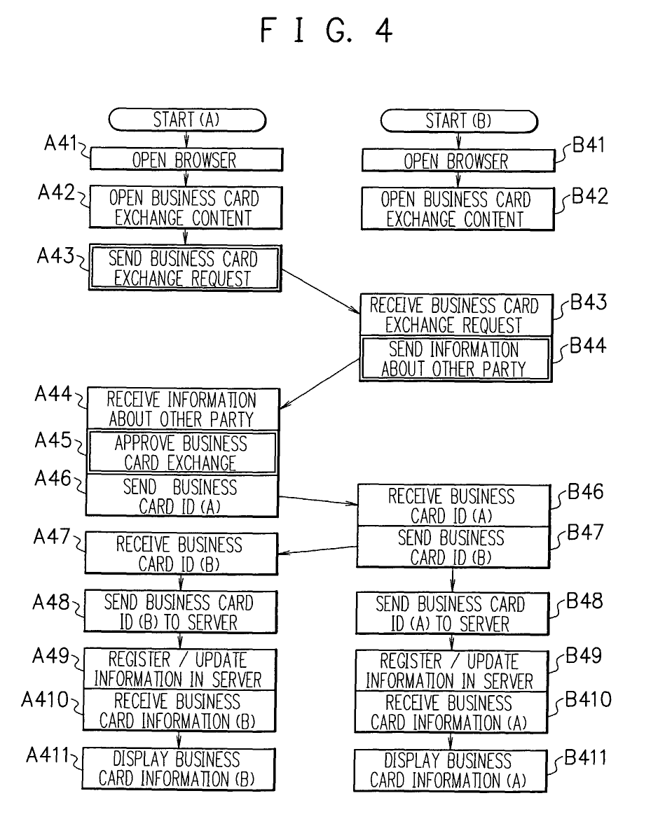

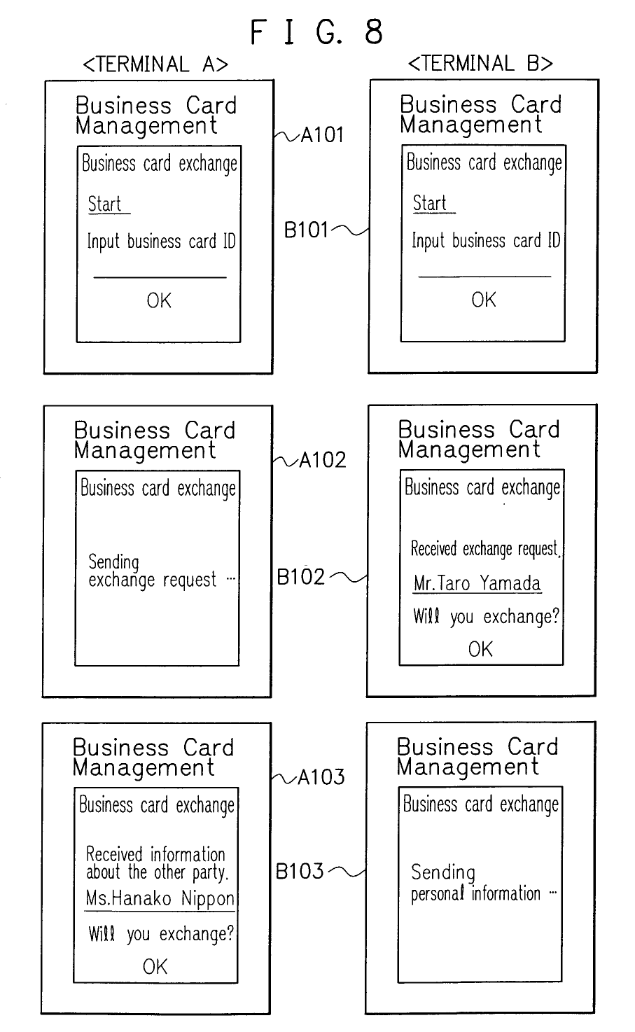

FIG. 4 is a flowchart showing behavior of a business card managing system (a business card managing method) according to the second embodiment of the present invention. FIG. 8 is a diagram showing transition of images displayed on the display sections of the respective portable terminals A101 and B102 in the business card managing method according to the second embodiment.

In reference to FIG. 4, the users A and B display the business card exchange contents in the same manner as described in Steps A31, A32, B31 and B32 in the first embodiment (Steps A41, A42, B41 and B42). Subsequently, the users A and B operate the operating sections 204, respectively, to select the “Business card exchange” on the screen display.

After the users A and B have finished the above processes, either of the users A or B (hereat, the user A) operates the operating section 204 to select “Start” on the screen display (Images A101 and B101 as shown in FIG. 8). The control section 203 of the portable terminal A101 sends personal information such as the name to the portable terminal B102 through the external IF section 205 (Step A43) (Image A102). The portable terminal B102 receives the personal information (Step B43) to display a confirmation screen on the display section 202 thereof (Image B102).

Having confirmed that the other party is the user A, the user B operates the operating section 204 to indicate approval of the exchange, and sends personal information such as the name to the portable terminal A101 (Step B44) (Image B103). Having received the personal information (Step A44), the portable terminal A101 displays the information of the other party on the display section 202 (Image A103). Having confirmed that the other party is the user B, the user A operates the operating section 204 to indicate approval of the exchange (Step A45). Subsequently, the control section 203 of the portable terminal A101 sends the business card ID (A) to the portable terminal B102 (Step A46).

The portable terminal B102 receives the business card ID (A) through the external IF section 205 (Step B46). Subsequently, the portable terminal B102 sends the business card ID (B) to the portable terminal A101 through the external IF section 205 (Step B47). Thereafter, the portable terminal A101 receives the business card ID (B) through the external IF section 205 thereof (Step A47).

The following Steps A48 to A411 and B48 to B411 are the same as Steps A36 to A39 and B36 to B39 in the first embodiment described previously in connection with FIG. 3, respectively, thereby abbreviating the explanation.

[Third Embodiment]

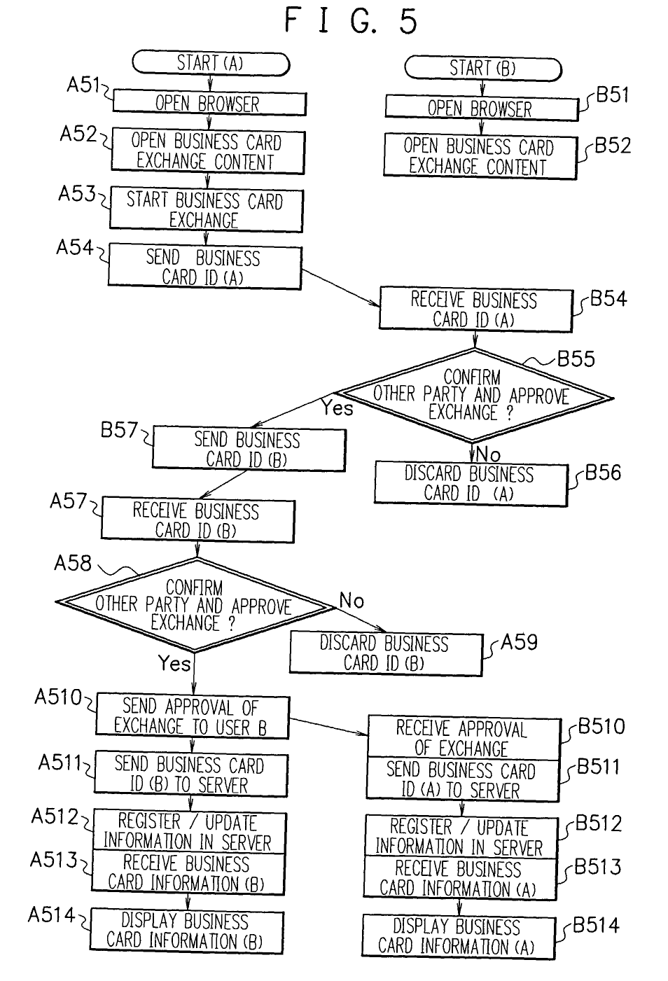

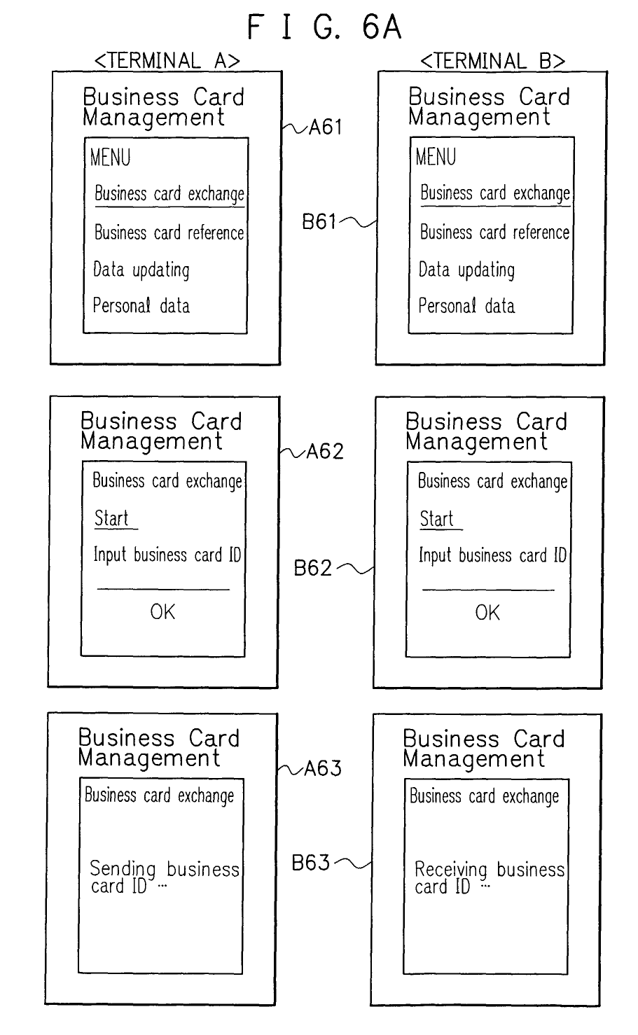

In the following, a detailed explanation is given of a third embodiment of the present invention referring to FIG. 5. FIG. 5 is a flowchart for explaining behavior of a business card managing system (a business card managing method) according to the third embodiment of the present invention. In the second embodiment, to identify the other party, the business card IDs are exchanged after the operation in Steps A43 to A45 (and associated Steps B43 and B44) shown in FIG. 4. On the other hand, in the third embodiment, as shown in FIG. 5, when a user who requests an exchange of business cards transmits his or her business card ID to the other party but the other party does not approve the exchange, the received business card ID is discarded.

In reference to FIG. 5, the users A and B display the business card exchange contents in the same manner as described in, for example, Steps A31, A32, B31 and B32 in the first embodiment (Steps A51, A52, B51 and B52). Subsequently, the users A and B operate the operating sections 204, respectively, to select the “Business card exchange” on the screen display.

After the users A and B have finished the above processes, either of the users A or B (hereat, the user A) operates the operating section 204 to select “Start” on the screen display (Step A53). The control section 203 of the portable terminal A101 sends the business card ID (A) including minimal necessary data such as the user's name, etc. to the portable terminal B102 through the external IF section 205 (Step A54).

Having received the business card ID (A) (Step B54), the portable terminal B102 displays a confirmation screen on the display section 202. Having confirmed that the other party is the user A, the user B operates the operating section 204 to indicate approval of the exchange (Step B55/Yes). Triggered by the indication, the control section 203 of the portable terminal B102 sends the business card ID (B) including minimal necessary data such as the user's name, etc. to the portable terminal A101 (Step B57). On the other hand, when the user B does not approve the exchange (Step B55/No), the control section 203 of the portable terminal B102 discards the received business card ID (A) (Step B56).

Having received the business card ID (B) (Step A57), the portable terminal A101 display the information about the other party on the display section 202 thereof. Having confirmed that the other party is the user B, the user A operates the operating section 204 to indicate the approval of the exchange (Step A58/Yes). Triggered by the indication, the control section 203 of the portable terminal A101 sends the approval of the exchange to the portable terminal B102 (Step A510). The portable terminal B102 receives the approval through the external IF section 205 thereof (Step B510). On the other hand, when the user A does not approve the exchange (Step A58/No), the control section 203 of the portable terminal A101 discards the received business card ID (B) (Step A59).

The following Steps A511 to A514 and B511 to B514 are the same as Steps A36 to A39 and B36 to B39 in the first embodiment described previously in connection with FIG. 3, respectively, thereby abbreviating the explanation.

The third embodiment in the above explanation differs from the second embodiment in that: the portable terminal A101 sends the business card ID (A) to the portable terminal B102 through the external IF section 205 thereof (Step A54); the portable terminal B102 receives the business card ID (A) through the external IF section 205 thereof (Step B54); and having confirmed the other party, when the user B does not approve the exchange (Step B55/No), the business card ID (A) is discarded (Step B56).

Referred again to the first and second embodiments, the above explanation in the first embodiment is an example where the external IF sections 205 are composed of devices having directivity to identify the other person based on IrDA, or the like. On the other hand, the above explanation in the second embodiment is an example where the external IF sections 205 are composed of devices having no or less directivity and difficulty in identifying the other party based on Bluetooth using weak radio waves, or the like.

Incidentally, the business card managing method of the present invention can be realized by having a computer execute a program(s). The program may be provided in an optical recording medium, a magnetic recording medium, a magnet-optical recording medium, a semiconductor IC recording medium or the like. Otherwise, the program may be downloaded via a network based on the FTP (File Transfer Protocol).

Incidentally, while the present invention has been described in terms of preferred embodiments, it is not limited thereto and can be variously changed and modified within the scope of the invention.

For example, while in the above explanation a mobile phone is taken as an example for the portable terminal, the portable terminal is only required to be a mobile terminal that can be connected to the server 130 such as PDA (Personal Digital Assistance), PHS (Personal Handyphone System), a small notebook computer and the like. In addition, a wristwatch or the other wearable apparatus may be adopted as the portable terminal if it has a network connection function.

Moreover, in addition to the columns of the business card database shown in FIG. 9, such columns as a mobile phone number, an e-mail address of the mobile phone, a business phone number, a business e-mail address may be added. Moreover, all or the part of the columns shown in FIG. 9 may be written in other language such as Chinese and the like.

Incidentally, when browsing a business card that has been registered in the personal database (namely, a business card that has been received/sent from someone), a user has only to send the corresponding business card ID to the server by, for example, opening the “Business card reference” in the menu shown in FIG. 6. Subsequently, the required business card data is downloaded from the server.

In addition, in the above embodiments, the users A and B exchange their business card IDs after they open the business card exchange contents. However, it is also possible to configure the system so that either user A or B may send his or her business card ID to the other party when the other party has not opened the content.

Moreover, the server may manage access history, update history and the like to effectively execute data processing such as updating. For example, when business card data is updated, the server may send an information message to the portable terminal(s) that stores the business card ID corresponding to the updated business card data.

Furthermore, it is also possible to send business card data to the other party unilaterally. For example, when the user A wants to send his business card data to the user B, the user A sends the business card ID (A) to the server and the server sends the business card data of the user A to the user B. When the user B is in the region outside of communication range, the server may send the business card data to the user B after the user B enters in the region within communication range.

Besides, while in the above embodiments the business card IDs are exchanged between two users, it is also possible to exchange IDs among three or more users.

As set forth hereinbefore, the first advantage of the present invention lies in the fact that users of portable terminals do not have to carry around paper business cards. This is because the electronic business cards can be exchanged, that is, data for the business cards can be exchanged over the portable terminals.

The second advantage of the present invention lies in the fact that users have only to store business card IDs in the portable terminals instead of all of the business card data, and thereby, there is no need for reserving fixed area in the memory of the portable terminal. This is because all of the business card data is stored in the internet server, and a user can download data corresponding to a business card ID to the portable terminal for use.

The third advantage of the present invention lies in the fact that the business card data can be easily updated. This is because the business card data is in the internet server. If the data in the server is updated, the portable terminal is to download the “updated data”. Thereby, users no longer need to be concerned about the operation for the update.

The fourth advantage of the present invention lies in the fact that the business card IDs can be exchanged only by the portable terminals, and thereby, it becomes possible to exchange the business card IDs even when the portable terminals are in the region outside of a service network, that is, in the region outside of communication range. This is because the business card IDs are exchanged each other by IrDA, Bluetooth, or operation input by hand, etc. Thereby, the portable terminal network is not used at this point. When the portable terminals are in the region outside of communication range, minimally necessary data (names, phone numbers and the like) is exchanged between the terminals in addition to the business card IDs for the moment. Then, after entering into the region inside of communication range, the registration in the internet server and the download of requested data are executed.

The fifth advantage of the present invention lies in the fact that, even when there is a possibility of sending data to unspecified number of people because of using wireless communication based on Bluetooth or the like, it is possible to infallibly exchange data (the business card IDs) with the intended other party. This is because every user confirms the other party before exchanging the business card IDs.

The sixth advantage of the present invention lies in the fact that a user can refuse to receive unnecessary business card data (information). This is because the user can discard a received business card ID when not accepting the exchange of the business cards.

The seventh advantage of the present invention lies in the fact that, when the portable terminals are in the region outside of communication range, the users can browse the business card data in the portable terminal. This is because the portable terminals each have a browser cache. Thereby, even when failing in downloading desired data from the internet server, the users can browse previously downloaded data.

The eighth advantage of the present invention lies in the fact that it becomes possible to make a call, send e-mail and the like while browsing the business card data. This is because the users read the business card data on the browser, and thereby, the basic function of the browser such as “phone to”, “mail to” and the like can be used meanwhile.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A business card managing system comprising:
a business card managing server including a first database for managing all personal information registered by a plurality of users via a network and a second database composed of areas assigned for the respective users for managing the personal information with respect to each user; and
a plurality of portable terminals each including an external interface to exchange business card IDs used for accessing the personal information managed by the business card managing server.

2. A business card managing system comprising:
a business card managing server including a first database for managing all personal information registered by a plurality of users via a network and a second database composed of areas assigned for the respective users for managing the personal information with respect to each user; and
a plurality of portable terminals each including an external interface to exchange business card IDs used for accessing the personal information managed by the business card managing server, wherein:
the portable terminal sends via the network a business card ID received from another portable terminal through the external interface to the business card managing server; and
when receiving the business card ID from the portable terminal, the business card managing server sends personal information that is managed in the first database and corresponds to the business card ID back to the portable terminal via the network.

3. A business card managing system comprising:
a business card managing server including a first database for managing all personal information registered by a plurality of users via a network and a second database composed of areas assigned for the respective users for managing the personal information with respect to each user; and
a plurality of portable terminals each including an external interface to exchange business card IDs used for accessing the personal information managed by the business card managing server, wherein:
the portable terminal sends via the network a business card ID received from another portable terminal through the external interface to the business card managing server; and
when receiving the business card ID from the portable terminal, in the case where the business card ID has not been registered in an area for a user of the portable terminal in the second database, the business card managing server registers therein the business card ID and sends personal information that is managed in the first database and corresponds to the business card ID back to the portable terminal via the network; or
when receiving the business card ID from the portable terminal, in the case where the business card ID has been registered in the area for the user of the portable terminal in the second database, the business card managing server sends personal information that is managed in the first database and corresponds to the business card ID back to the portable terminal via the network.

4. The business card managing system as claimed in claim 2, wherein:
the personal information is registered and updated through the portable terminal or a personal computer via the network; and
when receiving the business card ID from the portable terminal, the business card managing server sends the latest personal information that corresponds to the business card ID back to the portable terminal.

5. The business card managing system as claimed in claim 3, wherein:
the personal information is registered and updated through the portable terminal or a personal computer via the network; and
when receiving the business card ID from the portable terminal, the business card managing server sends the latest personal information that corresponds to the business card ID back to the portable terminal.

6. The business card managing system as claimed in claim 2, wherein
when the portable terminal exchanges business card IDs with the another portable terminal through the external interface, the portable terminals exchange data to identify users of the business card IDs along with the respective business card IDs to have each user confirm authenticity of the business card ID of the other party.

7. The business card managing system as claimed in claim 3, wherein
when the portable terminal exchanges business card IDs with the another portable terminal through the external interface, the portable terminals exchange data to identify users of the business card IDs along with the respective business card IDs to have each user confirm authenticity of the business card ID of the other party.

8. The business card managing system as claimed in claim 2, wherein:
the personal information is registered and updated through the portable terminal or a personal computer via the network;
when receiving the business card ID from the portable terminal, the business card managing server sends the latest personal information that corresponds to the business card ID back to the portable terminal; and
when the portable terminal exchanges business card IDs with the another portable terminal through the external interface, the portable terminals exchange data to identify users of the business card IDs along with the respective business card IDs to have each user confirm authenticity of the business card ID of the other party.

9. The business card managing system as claimed in claim 3, wherein:
the personal information is registered and updated through the portable terminal or a personal computer via the network;
when receiving the business card ID from the portable terminal, the business card managing server sends the latest personal information that corresponds to the business card ID back to the portable terminal; and
when the portable terminal exchanges business card IDs with the another portable terminal through the external interface, the portable terminals exchange data to identify users of the business card IDs along with the respective business card IDs to have each user confirm authenticity of the business card ID of the other party.

10. The business card managing system as claimed in claim 2, wherein
the portable terminal includes a means to discard the business card ID received from the another portable terminal through the external interface according to a direction from a user of the portable terminal.

11. The business card managing system as claimed in claim 3, wherein
the portable terminal includes a means to discard the business card ID received from the another portable terminal through the external interface according to a direction from the user of the portable terminal.

12. The business card managing system as claimed in claim 2, wherein:
the personal information is registered and updated through the portable terminal or a personal computer via the network;
when receiving the business card ID from the portable terminal, the business card managing server sends the latest personal information that corresponds to the business card ID back to the portable terminal; and
the portable terminal includes a means to discard the business card ID received from the another portable terminal through the external interface according to a direction from a user of the portable terminal.

13. The business card managing system as claimed in claim 3, wherein:
the personal information is registered and updated through the portable terminal or a personal computer via the network;
when receiving the business card ID from the portable terminal, the business card managing server sends the latest personal information that corresponds to the business card ID back to the portable terminal; and
the portable terminal includes a means to discard the business card ID received from the another portable terminal through the external interface according to a direction from a user of the portable terminal.

14. The business card managing system as claimed in claim 2, wherein
when the portable terminal exchanges business card IDs with the another portable terminal through the external interface, the portable terminals exchange data to identify users of the business card IDs along with the respective business card IDs to have each user confirm authenticity of the business card ID of the other party; and
the portable terminal includes a means to discard the business card ID received from the another portable terminal through the external interface means according to a direction from the user of the portable terminal.

15. The business card managing system as claimed in claim 3, wherein
when the portable terminal exchanges business card IDs with the another portable terminal through the external interface, the portable terminals exchange data to identify users of the business card IDs along with the respective business card IDs to have each user confirm authenticity of the business card ID of the other party; and
the portable terminal includes a means to discard the business card ID received from the another portable terminal through the external interface means according to a direction from the user of the portable terminal.

16. The business card managing system as claimed in claim 2, wherein:
the personal information is registered and updated through the portable terminal or a personal computer via the network;
when receiving the business card ID from the portable terminal, the business card managing server sends the latest personal information that corresponds to the business card ID back to the portable terminal;
when the portable terminal exchanges business card IDs with the another portable terminal through the external interface, the portable terminals exchange data to identify users of the business card IDs along with the respective business card IDs to have each user confirm authenticity of the business card ID of the other party; and
the portable terminal includes a means to discard the business card ID received from the another portable terminal through the external interface means according to a direction from the user of the portable terminal.

17. The business card managing system as claimed in claim 3, wherein:
the personal information is registered and updated through the portable terminal or a personal computer via the network;
when receiving the business card ID from the portable terminal, the business card managing server sends the latest personal information that corresponds to the business card ID back to the portable terminal;
when the portable terminal exchanges business card IDs with the another portable terminal through the external interface, the portable terminals exchange data to identify users of the business card IDs along with the respective business card IDs to have each user confirm authenticity of the business card ID of the other party; and
the portable terminal includes a means to discard the business card ID received from the another portable terminal through the external interface means according to a direction from the user of the portable terminal.

18. A business card managing method comprising:
a business card ID sending step for sending, from a portable terminal via a network, a business card ID acquired from another portable terminal to a business card managing server that includes a first database for managing all personal information registered by a plurality of users and a second database composed of areas assigned for the respective users for managing the personal information with respect to each user; and
a personal information sending step for, when the business card managing server receives the business card ID from the portable terminal, sending personal information that is managed in the first database and corresponds to the business card ID back to the portable terminal via the network.

19. A business card managing method comprising:
a business card ID sending step for sending, from a portable terminal via a network, a business card ID acquired from another portable terminal to a business card managing server that includes a first database for managing all personal information registered by a plurality of users and a second database composed of areas assigned for the respective users for managing the personal information with respect to each user; and
a registering and personal information sending step for, when the business card managing server receives the business card ID from the portable terminal, in the case where the business card ID has not been registered in an area for a user of the portable terminal in the second database, registering therein the sent business card ID and sending personal information that is managed in the first database and corresponds to the business card ID back to the portable terminal via the network; or
a personal information sending step for, when the business card managing server receives the business card ID from the portable terminal, in the case where the business card ID has been registered in the area for the user of the portable terminal in the second database, sending personal information that is managed in the first database and corresponds to the business card ID back to the portable terminal via the network.

20. A business card managing method comprising:
a first business card ID sending step for sending a business card ID of a user of a portable terminal through an external interface of the portable terminal to a portable terminal of an exchange party, the business card ID being registered in a business card managing server that includes a first database for managing all personal information registered by a plurality of users and a second database composed of areas assigned for the respective users for managing the personal information with respect to each user;
a business card ID receiving step for receiving, through the external interface, a business card ID of the exchange party sent from the portable terminal of the exchange party;
a second business card ID sending step for sending the received business card ID to the business card managing server via a network; and
a personal information sending step for, when the business card managing server receives the business card ID from the portable terminal, sending personal information that is managed in the first database and corresponds to the business card ID back to the portable terminal via the network.

21. A business card managing method comprising:
a first business card ID sending step for sending a business card ID of a user of a portable terminal through an external interface of the portable terminal to a portable terminal of an exchange party, the business card ID being registered in a business card managing server that includes a first database for managing all personal information registered by a plurality of users and a second database composed of areas assigned for the respective users for managing the personal information with respect to each user;
a business card ID receiving step for receiving, thorugh the external interface, a business card ID of the exchange party sent from the portable terminal of the exchange party;
a second business card ID sending step for sending the received business card ID to the business card managing server via a network; and
a registering and personal information sending step for, when the business card managing server receives the business card ID from the portable terminal, in the case where the business card ID has not been registered in an area for the user of the portable terminal in the second database, registering therein the business card ID sent in the second business card ID sending step and sending personal information that is managed in the first database and corresponds to the business card ID back to the portable terminal via the network; or
a personal information sending step for, when the business card managing server receives the business card ID from the portable terminal, in the case where the business card ID has been registered in the area for the user of the portable terminal in the second database, sending personal information that is managed in the first database and corresponds to the business card ID back to the portable terminal via the network.

22. The business card managing method as claimed in claim 18, further including
a registering and updating step for registering and updating the personal information through the portable terminal or a personal computer via the network; wherein
in the personal information sending step, when the business card managing server receives the business card ID from the portable terminal, the latest personal information that corresponds to the business card ID is sent back to the portable terminal.

23. The business card managing method as claimed in claim 19, further including
a registering and updating step for registering and updating the personal information through the portable terminal or a personal computer via the network; wherein
in the registering and personal information sending step or the personal information sending step, when the business card managing server receives the business card ID from the portable terminal, the latest personal information that corresponds to the business card ID is sent back to the portable terminal.

24. The business card managing method as claimed in claim 20, further including
a registering and updating step for registering and updating the personal information through the portable terminal or a personal computer via the network; wherein
in the personal information sending step, when the business card managing server receives the business card ID from the portable terminal, the latest personal information that corresponds to the business card ID is sent back to the portable terminal.

25. The business card managing method as claimed in claim 21, further including
a registering and updating step for registering and updating the personal information through the portable terminal or a personal computer via the network; wherein
in the registering and personal information sending step or the personal information sending step, when the business card managing server receives the business card ID from the portable terminal, the latest personal information that corresponds to the business card ID is sent back to the portable terminal.

26. The business card managing method as claimed in claim 20, wherein
in the first business card ID sending step, at the time of sending the business card ID to the portable terminal of the exchange party, data to identify the user of the business card ID is sent along with the business card ID; further including
a confirming step for receiving the data for identification along with the business card ID received in the business card ID receiving step to have the user of the portable terminal confirm authenticity of the business card ID.

27. The business card managing method as claimed in claim 21, wherein
in the first business card ID sending step, at the time of sending the business card ID to the portable terminal of the exchange party, data to identify the user of the business card ID is sent along with the business card ID; further including
a confirming step for receiving the data for identification along with the business card ID received in the business card ID receiving step to have the user of the portable terminal confirm authenticity of the business card ID.

28. The business card managing method as claimed in claim 20, further including
a business card ID discarding step for discarding the business card ID according to a direction from the user of the portable terminal after receiving the business card ID in the business card ID receiving step.

29. The business card managing method as claimed in claim 21, further including
a business card ID discarding step for discarding the business card ID according to a direction from the user of the portable terminal after receiving the business card ID in the business card ID receiving step.

30. The business card managing method as claimed in claim 20, wherein
in the first business card ID sending step, at the time of sending the business card ID to the portable terminal of the exchange party, data to identify the user of the business card ID is sent along with the business card ID; further including
a confirming step for receiving the data for identification along with the business card ID received in the business card ID receiving step to have the user of the portable terminal confirm authenticity of the business card ID; and
a business card ID discarding step for discarding the business card ID according to a direction from the user of the portable terminal after receiving the business card ID in the business card ID receiving step.

31. The business card managing method as claimed in claim 21, wherein
in the first business card ID sending step, at the time of sending the business card ID to the portable terminal of the exchange party, data to identify the user of the business card ID is sent along with the business card ID; further including
a confirming step for receiving the data for identification along with the business card ID received in the business card ID receiving step to have the user of the portable terminal confirm authenticity of the business card ID; and
a business card ID discarding step for discarding the business card ID according to a direction from the user of the portable terminal after receiving the business card ID in the business card ID receiving step.

32. A computer readable program to have a computer execute:
a business card ID sending process for sending, from a portable terminal via a network, a business card ID acquired from another portable terminal to a business card managing server that includes a first database for managing all personal information registered by a plurality of users and a second database composed of areas assigned for the respective users for managing the personal information with respect to each user; and
a personal information sending process for, when the business card managing server receives the business card ID from the portable terminal, sending personal information that is managed in the first database and corresponds to the business card ID back to the portable terminal via the network.

33. A computer readable program to have a computer execute:
a business card ID sending process for sending, from a portable terminal via a network, a business card ID acquired from another portable terminal to a business card managing server that includes a first database for managing all personal information registered by a plurality of users and a second database composed of areas assigned for the respective users for managing the personal information with respect to each user; and
a registering and personal information sending process for, when the business card managing server receives the business card ID from the portable terminal, in the case where the business card ID has not been registered in an area for a user of the portable terminal in the second database, registering therein the sent business card ID and sending personal information that is managed in the first database and corresponds to the business card ID back to the portable terminal via the network; or
a personal information sending process for, when the business card managing server receives the business card ID from the portable terminal, in the case where the business card ID has been registered in the area for the user of the portable terminal in the second database, sending personal information that is managed in the first database and corresponds to the business card ID back to the portable terminal via the network.

34. A computer readable program to have a computer execute:
a first business card ID sending process for sending a business card ID of a user of a portable terminal from an external interface of the portable terminal to a portable terminal of an exchange party, the business card ID being registered in a business card managing server that includes a first database for managing all personal information registered by a plurality of users and a second database composed of areas assigned for the respective users for managing the personal information with respect to each user;
a business card ID receiving process for receiving, through the external interface, a business card ID of the exchange party sent from the portable terminal of the exchange party;
a second business card ID sending process for sending the received business card ID to the business card managing server via a network; and
a personal information sending process for, when the business card managing server receives the business card ID from the portable terminal, sending personal information that is managed in the first database and corresponds to the business card ID back to the portable terminal via the network.

35. A computer readable program to have a computer execute:
a first business card ID sending process for sending a business card ID of a user of a portable terminal from an external interface of the portable terminal to a portable terminal of an exchange party, the business card ID being registered in a business card managing server that includes a first database for managing all personal information registered by a plurality of users and a second database composed of areas assigned for the respective users for managing the personal information with respect to each user;
a business card ID receiving process for receiving, through the external interface, a business card ID of the exchange party sent from the portable terminal of the exchange party;
a second business card ID sending process for sending the received business card ID to the business card managing server via a network; and
a registering and personal information sending process for, when the business card managing server receives the business card ID from the portable terminal, in the case where the business card ID has not been registered in an area for the user of the portable terminal in the second database, registering therein the business card ID sent in the second business card ID sending process and sending personal information that is managed in the first database and corresponds to the business card ID back to the portable terminal via the network; or
a personal information sending process for, when the business card managing server receives the business card ID from the portable terminal, in the case where the business card ID has been registered in the area for the user of the portable terminal in the second database, sending personal information that is managed in the first database and corresponds to the business card ID back to the portable terminal via the network.

36. The computer readable program, as claimed in claim 32, to have a computer further execute
a registering and updating process for registering and updating the personal information through the portable terminal or a personal computer via the network; wherein
by the personal information sending process, when the business card managing server receives the business card ID from the portable terminal, the latest personal information that corresponds to the business card ID is sent back to the portable terminal.

37. The computer readable program, as claimed in claim 33, to have a computer further execute
a registering and updating process for registering and updating the personal information through the portable terminal or a personal computer via the network; wherein
by the registering and personal information sending process or the personal information sending process, when the business card managing server receives the business card ID from the portable terminal, the latest personal information that corresponds to the business card ID is sent back to the portable terminal.

38. The computer readable program, as claimed in claim 34, to have a computer further execute
a registering and updating process for registering and updating the personal information through the portable terminal or a personal computer via the network; wherein
by the personal information sending process, when the business card managing server receives the business card ID from the portable terminal, the latest personal information that corresponds to the business card ID is sent back to the portable terminal.

39. The computer readable program, as claimed in claim 35, to have a computer further execute
a registering and updating process for registering and updating the personal information through the portable terminal or a personal computer via the network; wherein
by the registering and personal information sending process or the personal information sending process, when the business card managing server receives the business card ID from the portable terminal, the latest personal information that corresponds to the business card ID is sent back to the portable terminal.

40. A business card managing server
comprising:
a first database for managing all personal information registered by a plurality of users via a network; and
a second database that is composed of areas assigned for the respective users for managing the personal information with respect to each user, in each of which at least one business card ID used for accessing the personal information is registered with a portable terminal via a network; and
when receiving a business card ID from a portable terminal via the network, sending personal information that is managed in the first database and corresponds to the business card ID back to the portable terminal via the network.

41. A business card managing server
comprising:
a first database for managing all personal information registered by a plurality of users via a network; and
a second database that is composed of areas assigned for the respective users for managing the personal information with respect to each user, in each of which at least one business card ID used for accessing the personal information is registered with a portable terminal via a network; and
when receiving the business card ID from the portable terminal, in the case where the business card ID has not been registered in an area for a user of the portable terminal in the second database, registering therein the business card ID and sending personal information that is managed in the first database and corresponds to the business card ID back to the portable terminal via the network; or
when receiving the business card ID from the portable terminal, in the case where the business card ID has been registered in the area for the user of the portable terminal in the second database, sending personal information that is managed in the first database and corresponds to the business card ID back to the portable terminal via the network.

42. The business card managing server as claimed in claim 40:
registering and updating the personal information sent from the portable terminal or a personal computer via the network; and
when receiving the business card ID from the portable terminal, sending the latest personal information that corresponds to the business card ID back to the portable terminal.

43. The business card managing server as claimed in claim 41:
registering and updating the personal information sent from the portable terminal or a personal computer via the network; and
when receiving the business card ID from the portable terminal, sending the latest personal information that corresponds to the business card ID back to the portable terminal.

44. A computer readable program for controlling a business card managing server that includes a first database for managing all personal information registered by a plurality of users and a second database composed of areas assigned for the respective users for managing the personal information with respect to each user, to have a computer execute:
a receiving process for receiving a business card ID from a portable terminal via the network; and
a personal information sending process for, when the business card managing server receives the business card ID from the portable terminal, sending personal information that is managed in the first database and corresponds to the business card ID back to the portable terminal via the network.

45. A computer readable program for controlling a business card managing server that includes a first database for managing all personal information registered by a plurality of users and a second database composed of areas assigned for the respective users for managing the personal information with respect to each user, to have a computer execute:
a receiving process for receiving a business card ID from a portable terminal via the network; and
a registering and personal information sending process for, when the business card managing server receives the business card ID from the portable terminal, in the case where the business card ID has not been registered in an area for a user of the portable terminal in the second database, registering therein the business card ID and sending personal information that is managed in the first database and corresponds to the business card ID back to the portable terminal via the network; or
a personal information sending process for, when the business card managing server receives the business card ID from the portable terminal, in the case where the business card ID has been registered in the area for the user of the portable terminal in the second database, sending personal information that is managed in the first database and corresponds to the business card ID back to the portable terminal via the network.

46. The computer readable program, as claimed in claim 44, to have a computer further execute
a registering and updating process for registering and updating the personal information sent from the portable terminal or a personal computer via the network; wherein
by the personal information sending process, when the business card managing server receives the business card ID from the portable terminal, the latest personal information that corresponds to the business card ID is sent back to the portable terminal.

47. The computer readable program, as claimed in claim 45, to have a computer further execute
a registering and updating process for registering and updating the personal information sent from the portable terminal or a personal computer via the network; wherein
by the registering and personal information sending process or the personal information sending process, when the business card managing server receives the business card ID from the portable terminal, the latest personal information that corresponds to the business card ID is sent back to the portable terminal.

48. A portable terminal comprising:
an external interface to exchange business card IDs used for accessing personal information managed in a business card managing server with another portable terminal in a range of local communication; and
a network interface to send a business card ID acquired from the another portable terminal through the external interface to the business card managing server via a network, and receive the latest personal information of a user of the another portable terminal, the latest personal information corresponding to the business card ID, from the business card managing server.

49. The portable terminal as claimed in claim 48, further including
a means to, when the portable terminal exchanges business card IDs with the another portable terminal through the external interface, exchange data to identify users of the business card IDs along with the respective business card IDs to have each user confirm authenticity of the business card ID of the other party.

50. The portable terminal as claimed in claim 48, further including
a means to discard the business card ID received from the another portable terminal through the external interface according to a direction from the user of the portable terminal.

51. The portable terminal as claimed in claim 48, further including:
a means to, when the portable terminal exchanges business card IDs with the another portable terminal through the external interface, exchange data to identify users of the business card IDs along with the respective business card IDs to have each user confirm authenticity of the business card ID of the other party; and
a means to discard the business card ID received from the another portable terminal through the external interface according to a direction from the user of the portable terminal.

52. A computer readable program to have a computer execute:
a first business card ID sending process for sending a business card ID of a user of a portable terminal from an external interface of the portable terminal to a portable terminal of an exchange party, the business card ID being registered in a business card managing server;
a business card ID receiving process for receiving, through the external interface, a business card ID of the exchange party sent from the portable terminal of the exchange party;
a second business card ID sending process for sending the received business card ID to the business card managing server via a network; and
a personal information receiving process for receiving the latest personal information of the exchange party, the latest personal information corresponding to the business card ID sent by the second business card ID sending process, from the business card managing server via the network.

53. The computer readable program as claimed in claim 52, wherein
by the first business card ID sending process, at the time of sending the business card ID to the portable terminal of the exchange party, data to identify the user of the business card ID is sent along with the business card ID; to have the computer further execute
a confirming process for receiving the data for identification along with the business card ID received in the business card ID receiving process to have the user of the portable terminal confirm authenticity of the business card ID.

54. The computer readable program, as claimed in claim 52, to have the computer further execute
a business card ID discarding process for discarding the business card ID according to a direction from the user of the portable terminal after receiving the business card ID by the business card ID receiving process.

55. The computer readable program as claimed in claim 52, wherein
by the first business card ID sending process, at the time of sending the business card ID to the portable terminal of the exchange party, data to identify the user of the business card ID is sent along with the business card ID; to have the computer further execute
a confirming process for receiving the data for identification along with the business card ID received in the business card ID receiving process to have the user of the portable terminal confirm authenticity of the business card ID; and
a business card ID discarding process for discarding the business card ID according to a direction from the user of the portable terminal after receiving the business card ID by the business card ID receiving process.
